(19) United States
(12) Patent Application Publication
(10) Pub. No.: US 2010/0273038 A1
(43) Pub. Date: Oct. 28, 2010

(54) BATTERY HOLDER FOR ELECTRONIC DEVICE

(75) Inventor: ZHI-HUA LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/548,640

(22) Filed: Aug. 27, 2009

(30) Foreign Application Priority Data
Apr. 27, 2009 (CN) 200910301897.0

(51) Int. Cl. H01M 2/10

(52) U.S. Cl. 429/98; 429/100

(57) ABSTRACT

A battery holder includes a main body and an electrically conductive sheet. The main body defines a chamber in the main body and a latching groove in a middle portion of an inner sidewall of the chamber. The electrically conductive sheet is fixed in the chamber and divides the chamber into a battery chamber and an additional chamber. The electrically conductive sheet includes at least two positioning portions extending from an edge of the electrically conductive sheet. The at least two positioning portions are elastically deformed and engaged in the latching groove such that the electrically conductive sheet is fixed in the chamber.

### BACKGROUND

1. Technical Field

The present disclosure relates to battery holders, and particularly, to a battery holder for an electronic device.

2. Description of the Related Art

Electronic devices, such as wireless keyboards, flashlights, and other device requiring power, are generally powered by batteries. A battery holder is often used to fix the batteries within the electronic devices.

A typical battery holder for a flashlight includes a main body, a front cover, a rear cover, a lamp socket, and a spring. The main body is substantially a cylindrical sleeve made of metallic material. The front cover and the rear cover are mounted in opposite ends of the main body. The lamp socket is fixed in the front cover. The spring is fixed in the rear cover. A plurality of batteries is received in the main body, and electrically contacts the lamp socket and the spring. However, there is insufficient space to receive other elements, such as a circuit board.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of a first embodiment of a battery holder and a battery, utilized in an electronic device.

FIG. 2 is a partial, exploded, isometric view of the electronic device shown in FIG. 1.

FIG. 3 is similar to FIG. 2, but viewed from another aspect.

FIG. 4 is a cross-section of the electronic device shown in FIG. 1.

FIG. 5 is a cross-section of a second embodiment of a battery holder for an electronic device.

### DETAILED DESCRIPTION

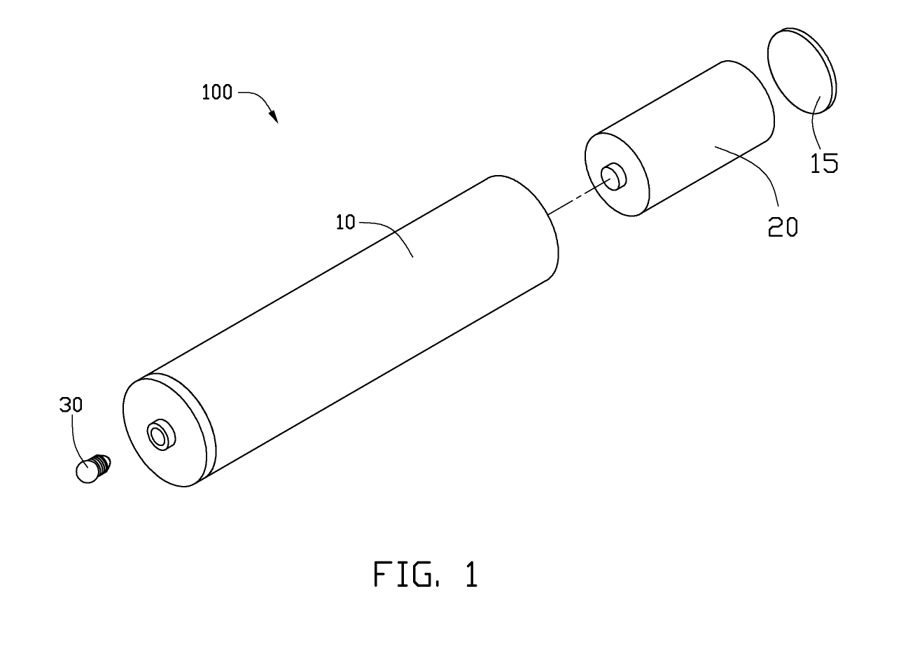

Referring to FIG. 1, a first embodiment of a battery holder 10 utilized in an electronic device 100, a battery 20 received in the battery holder 10, and a lamp 30 fixed to the battery holder 10 is shown. In the illustrated embodiment, the electronic device 100 is a flashlight, but any device supporting a battery holder such as a wireless keyboard, remote control, or other device is equally applicable. The lamp 30 can be, but is not limited to, a bulb.

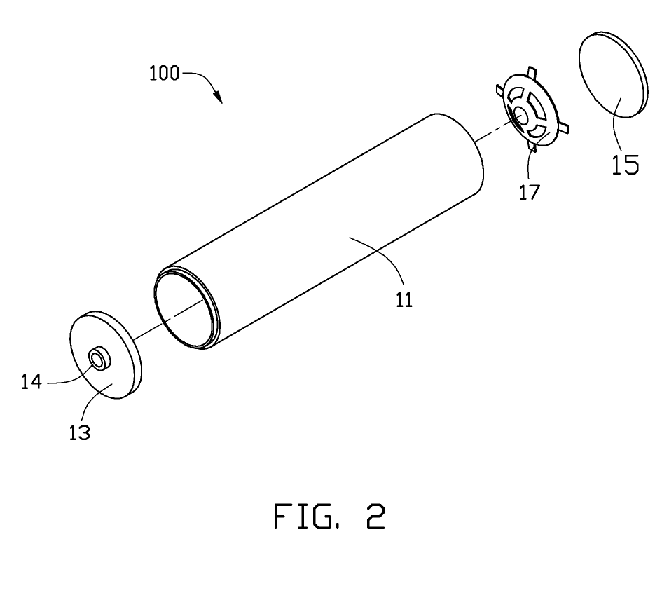

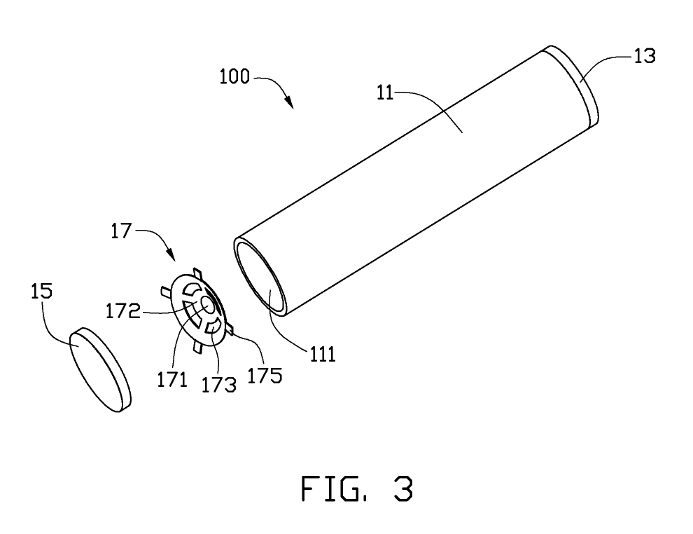

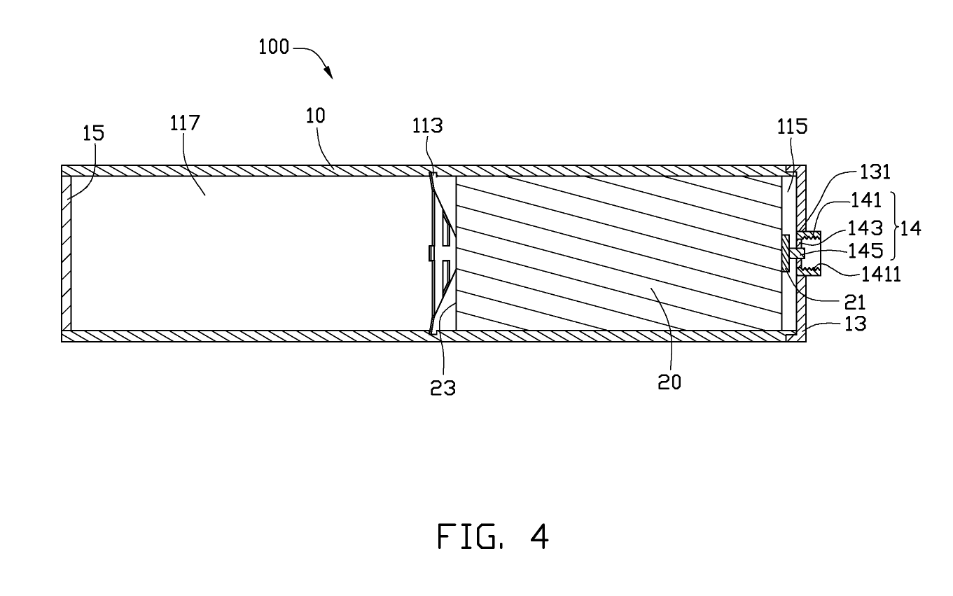

Referring to FIGS. 2 through 4, the battery holder 10 includes a main body 11, a front cover 13, a lamp socket 14, a rear cover 15, and an electrically conductive sheet 17. The main body 11 is a hollow cylinder. The main body 11 defines a chamber 111 to receive the battery 20 and the electrically conductive sheet 17. The front cover 13 and the rear cover 15 are correspondingly mounted in opposite ends of the main body 11. In the illustrated embodiment, the front cover 13 is permanently mounted in one end of the main body 11 by glue. Alternatively, the front cover 13 can be detachably mounted in the end of the main body 11 by fasteners such as screws. The lamp socket 14 is permanently mounted in the front cover 13 and detachably received in the lamp socket 14. The electrically conductive sheet 17 is electrically connected to the lamp socket 14 by leads (not shown).

The main body 11 is made of metallic material and defines a latching groove 113 in a middle portion of an inner sidewall of the chamber 111. In the illustrated embodiment, the latching groove 113 is an annular groove extending along a circumference of the chamber 111. The latching groove 113 can be easily formed by a T-shaped milling cutter.

The front cover 13 defines a fixing hole 131 in a middle portion thereof. In the illustrated embodiment, the front cover 13 is made of metallic material.

The lamp socket 14 includes a sleeve 141, an annular insulating sheet 143, and an electrically conductive pole 145. The sleeve 141 forms a plurality of inner threads 1411 to engage outer threads of the lamp 30, such that the lamp 30 is detachably supported in the sleeve 141. The insulating sheet 143 is positioned in an end of the sleeve 141. The electrically conductive pole 145 is inserted into the insulating sheet 143 and partially received in the sleeve 141. The electrically conductive pole 145 electrically interconnects the battery 20 and the lamp 30, and is insulated with the sleeve 141.

The electrically conductive sheet 17 may be substantially tray-shaped and include a resisting portion 172, a circular hole 171, four annular sector holes 173, and four positioning portions 175. The circular hole 171 is defined in a middle portion of the resisting portion 172. The four annular sector holes 173 are defined in the resisting portion 172 around the circular hole 171 and are evenly spaced from each other. The four positioning portions 175 extend from the annular edge of the resisting portion 172 and are engaged in the latching groove 113 of the main body 11, such that the electrically conductive sheet 17 is fixed in the chamber 111 of the main body 11. The electrically conductive sheet 17 divides the chamber 111 into a battery chamber 115 and an additional chamber 117 away from the front cover 13. The battery chamber 115 receives the battery 20. The additional chamber 117 is defined to receive other elements, such as a circuit board.

During assembly of the electronic device 100, the front cover 13 is mounted in an end of the main body 11. The electrically conductive sheet 17 is fixed in the chamber 111, such that the electrically conductive sheet 17 divides the chamber 111 of the main body 11 into the battery chamber 115 and the additional chamber 117. The four positioning portions 175 of the electrically conductive sheet 17 are elastically deformed and engaged in the latching groove 113. The resisting portion 172 of the electrically conductive sheet 17 protrudes toward the front cover 13 and electrically contacts the battery 20. The battery 20 is received in the battery chamber 115, and electrically contacts the electrically conductive pole 145 and the electrically conductive sheet 17.

It should be pointed out that the main body 113 can also define four latching grooves spaced from each other, in which the four positioning portions 175 are correspondingly engaged. The number of positioning portions 175 can alternatively be two, three, five, or more. The electrically conductive sheet 17 can also be substantially curved or contoured.

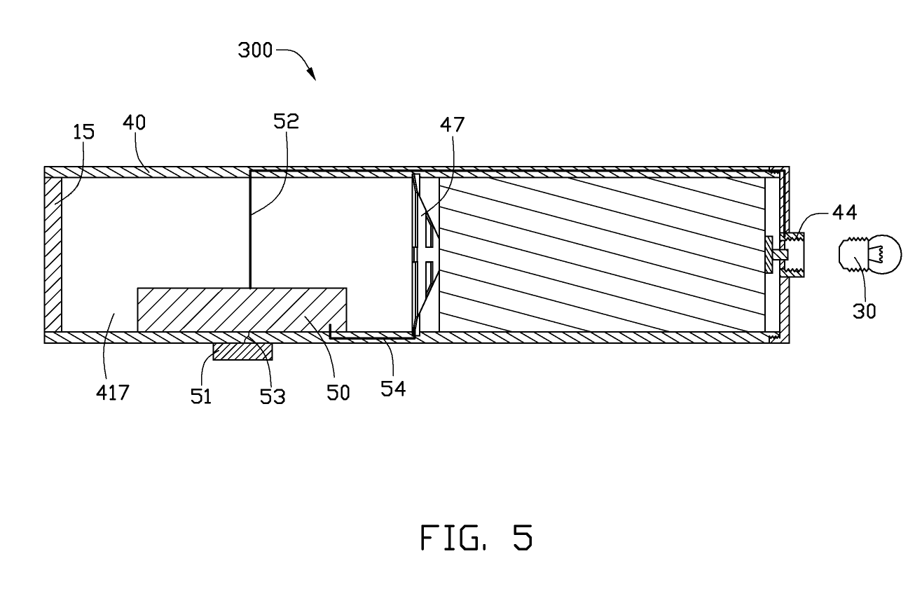

As shown in FIG. 5, a second embodiment of an electronic device 300 differs from the first embodiment of the electronic device 100 except for the inclusion of a current limiting module 50 and a switch 51. The current limiting module 50 is received in the additional chamber 417, and electrically connected to the lamp socket 44, the switch 51, and the electrically conductive sheet 47 by leads 52, 53, 54, respectively. The switch 51 is positioned in an outer surface of the main body 40 and drives the current limiting module 50 to change a brightness of the lamp 30.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A battery holder for an electronic device, comprising:
a main body defining a chamber therein and a latching groove in a middle portion of an inner sidewall of the chamber;
an electrically conductive sheet comprising at least two positioning portions extending from an edge thereof, wherein the at least two positioning portions are elastically deformed and engaged in the latching groove, such that the electrically conductive sheet is fixed in and dividing the chamber.

2. The battery holder of claim 1, wherein the main body is substantially a cylindrical sleeve and made of metallic materials.

3. The battery holder of claim 2, wherein the electrically conductive sheet further comprises a resisting portion; the at least two positioning portions extend from an annular edge of the resisting portion and are evenly spaced.

4. The battery holder of claim 3, wherein the resisting portion defines a circular hole in a middle portion thereof and four annular sector holes around the circular hole.

5. The battery holder of claim 1, further comprising a front cover fixedly disposed in an end of the main body and a lamp socket positioned in the front cover.

6. The battery holder of claim 5, wherein the lamp socket comprises a sleeve, an insulating sheet positioned in an end of the sleeve, and an electrical conductive pole inserting in the insulating sheet and partially received in the sleeve.

7. The battery holder of claim 5, further comprising a rear cover fixedly disposed in the other end of the main body opposite to the front cover.

8. The battery holder of claim 1, wherein the latching groove is an annular groove extending along a circumference of the chamber.

9. An electronic device, comprising:
a battery holder comprising a main body, a lamp socket, and an electrically conductive sheet, the main body defining a chamber therein and a latching groove in a middle portion of an inner sidewall of the chamber, the electrically conductive sheet comprising at least two positioning portions engaged in the latching groove to fix the electrically conductive sheet in the main body, wherein the chamber is divided by the electrically conductive sheet into a battery chamber and an additional chamber; the lamp socket is fixed in an end of the main body adjoining the battery chamber;
a battery received in the battery chamber and electrically contacting the electrically conductive sheet and the lamp socket; and
a lamp detachably supported in the lamp socket.

10. The electronic device of claim 9, wherein the main body is substantially a cylindrical sleeve and made of metallic materials.

11. The electronic device of claim 10, wherein the electrically conductive sheet further comprises a resisting portion; the at least two positioning portions extend from an annular edge of the resisting portion and are evenly spaced.

12. The electronic device of claim 11, wherein the resisting portion defines a circular hole in a middle portion thereof and four annular sector holes around the circular hole.

13. The electronic device of claim 9, wherein the battery holder further comprises a front cover fixedly disposed in an end of the main body and a lamp socket positioned in the front cover.

14. The electronic device of claim 13, wherein the lamp socket comprises a sleeve, an insulating sheet positioned in an end of the sleeve, and an electrical conductive pole inserting in the insulating sheet and partially received in the sleeve.

15. The electronic device of claim 13, wherein the battery holder further comprises a rear cover fixedly disposed in the other end of the main body opposite to the front cover.

16. The electronic device of claim 9, wherein the latching groove is an annular groove extending along a circumference of the chamber.

17. The electronic device of claim 9, further comprising a current limiting module received in the additional chamber, the current limiting module electrically connected to the electrically conductive sheet and lamp socket.

18. The electronic device of claim 17, further comprising a switch fixed in the outer surface of the main body and electrically connected to the current limiting module.
